(19) United States
(12) Patent Application Publication
(10) Pub. No.: US 2007/0071296 A1
(43) Pub. Date: Mar. 29, 2007

(54) Radiographic image processing apparatus for processing radiographic image taken with radiation, method of radiographic image processing, and computer program product therefor

(76) Inventors: Ryosuke Nonaka, Kanagawa (JP); Goh Itoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/378,232

(22) Filed: Mar. 20, 2006

(30) Foreign Application Priority Data
Sep. 28, 2005 (JP) 2005-281980

(51) Int. Cl. G06K 9/00

(52) U.S. Cl. 382/128

(57) ABSTRACT

A radiographic image processing apparatus includes a radiographic image inputting unit, an intermediate image generating unit, a large object image generating unit, and a small object image generating unit. The radio graphic image inputting unit inputs a radiographic image which is a frame of moving picture taken radiographically. The intermediate image generating unit generates an intermediate image whose pixel value is a maximum pixel value of pixels within each area of a first size in a radiographic image. The large object image generating unit generates a large object image whose pixel value is a minimum pixel value of pixels within each area of a second size in the intermediate image. The small object image generating unit generates a small object image whose pixel value is a difference between pixel value of the radiographic image and pixel value of the large object image corresponding to each pixel of the radiographic image.

### CROSS-REFERENCE TO RELATED APPLICATIONS

This application is based upon and claims the benefit of priority from the prior Japanese Patent Application No. 2005-281980, filed on Sep. 28, 2005; the entire contents of which are incorporated herein by reference.

### BACKGROUND OF THE INVENTION

1. Field of the Invention

The present invention relates to a radiographic image processing apparatus that processes a radiographic image taken with radiation, a method of radiographic image processing, and a computer program product therefor.

2. Description of the Related Art

Conventionally, in order to improve visibility of a moving image displayed in a radiation diagnosis apparatus, a noise reduction process is performed by spatial smoothing in which the smoothing is performed between adjacent pixels in the same image or by temporal smoothing in which the smoothing is performed among the pixels corresponding to the plural continuous images.

Generally, in the spatial smoothing, there is a drawback that material body included in the image has a dim outline. In the temporal smoothing, there is a drawback that an afterimage of the moving material body is displayed. The drawback that the afterimage is displayed is eliminated by omission of the smoothing for the region including the moving material body, for example.

Japanese Patent Application Laid-Open No. H06-154200 discloses a technique in which the region including the moving material body is separated from other regions by a movement detecting unit which detects the region including the moving material body, and the spatial smoothing is performed to the region including the moving material body, whereby the visibility is improved without the omission of the smoothing on the region including the moving material body.

In the technique disclosed in Japanese Patent Application Laid-Open No. H06-154200, however, since the spatial smoothing is performed to the region including the moving material body, there is a problem that the visibility is worsened for the small material body. For example, there is a problem that a doctor manipulating the radiation diagnosis apparatus has difficulty in seeing a small moving medical tool such as a guide wire, which the doctor is required to particularly-clearly confirm, since such a small tool appears only with a dim outline. This is because the same visibility improving process is performed without distinguishing the large material body from the small material body in Japanese Patent Application Laid-Open No. H06-154200.

### SUMMARY OF THE INVENTION

According to one aspect of the present invention, a radiographic image processing apparatus includes a radiographic image inputting unit configured to input a radiographic image being a frame of moving picture taken radiographically; an intermediate image generating unit configured to generate an intermediate image by computing a maximum pixel value as a pixel value of each pixel of the intermediate image, the maximum pixel value being a maximum pixel value of pixels within each area of a first size in a radiographic image, the each area of the first size including a pixel corresponding to the each pixel of the intermediate image; a large object image generating unit configured to generate a large object image by computing a minimum pixel value as a pixel value of each pixel of the large object image, the minimum pixel value being a minimum pixel value of pixels within each area of a second size in the intermediate image, the each area of the second size including a pixel corresponding to the each pixel of the large object image; and a small object image generating unit configured to generate a small object image by computing difference as a pixel value of each pixel of the small object image, the difference being difference of pixel values between the each pixel of the radiographic image and the each pixel of the large object image corresponding to the each pixel of the radiographic image.

According to another aspect of the present invention, a method of processing a radiographic image includes inputting a radiographic image being a frame of moving picture taken radiographically; generating an intermediate image by computing a maximum pixel value as a pixel value of each pixel of the intermediate image, the maximum pixel value being a maximum pixel value of pixels within each area of a first size in a radiographic image, the each area of the first size including a pixel corresponding to the each pixel of the intermediate image; generating a large object image by computing a minimum pixel value as a pixel value of each pixel of the large object image, the minimum pixel value being a minimum pixel value of pixels within each area of a second size in the intermediate image, the each area of the second size including a pixel corresponding to the each pixel of the large object image; and generating a small object image by computing difference as a pixel value of each pixel of the small object image, the difference being difference of pixel-values between the each pixel of the radiographic image and the each pixel of the large object image corresponding to the each pixel of the radiographic image.

A computer program product according to still another aspect of the present invention causes a computer to perform the method according to the present invention.

### BRIEF DESCRIPTION OF THE DRAWINGS

FIG. 1 is a block diagram showing a configuration of a radiographic image processing apparatus according to a first embodiment of the present invention;

FIG. 2 is a block diagram showing a detailed configuration of a large and small object separating unit;

FIG. 3 is a block diagram showing one example of a configuration of a large object computing unit;

FIG. 4 is a block diagram showing another example of the configuration of the large object computing unit;

FIG. 5 is a flowchart showing an entire flow of a radiographic image processing in the first embodiment;

FIG. 6 is a flowchart showing an entire flow of a still object computing process;

FIG. 7 is a flowchart showing an entire flow of an object region detecting process;

FIG. 8 is a flowchart showing an entire flow of an image enhancement process;

FIG. 9 is a block diagram showing a configuration of a radiographic image processing apparatus according to a second embodiment of the present invention; and

FIG. 10 is a flowchart showing an entire flow of the radiographic image processing in the second embodiment.

### DETAILED DESCRIPTION OF THE INVENTION

In a radiographic image processing apparatus according to a first embodiment of the present invention, a separation process of separating a large object which is larger than an object having a predetermined size from a small object which is an object other than the large object and a separation process of separating a moving object which is a moving material body from a still object which is a still material body are concurrently performed, a moving small object which is a small object in motion is computed by synthesizing the small object and the moving object, and the visibility improving process is performed to the computed moving small object.

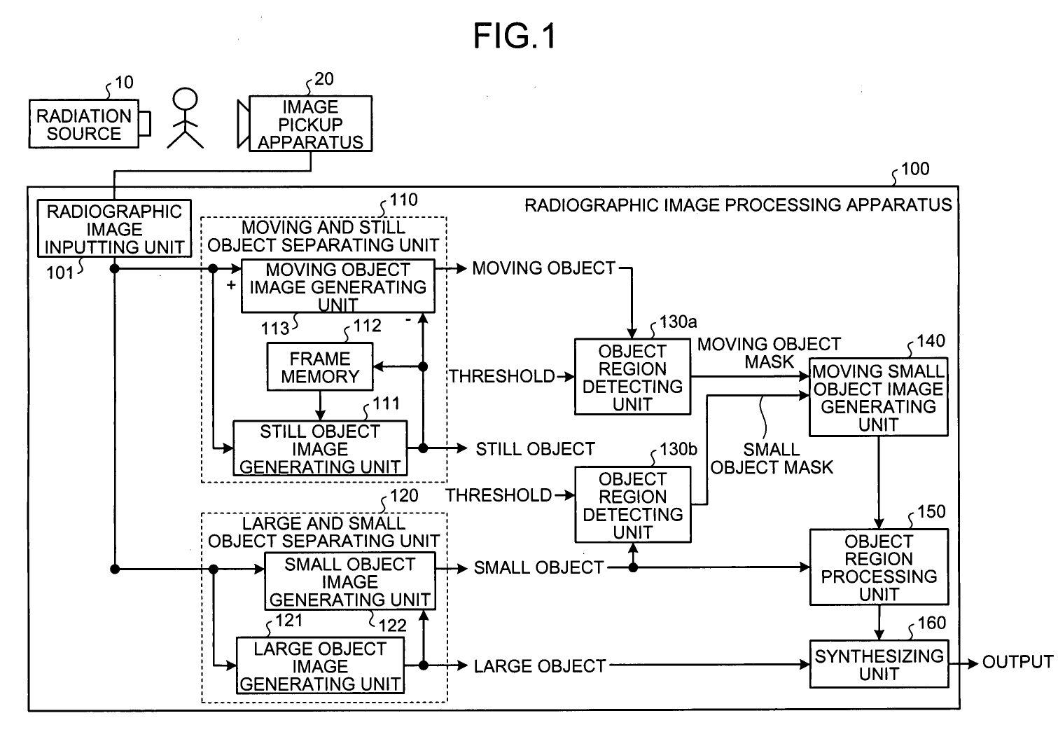

FIG. 1 is a block diagram showing a configuration of a radiographic image processing apparatus 100 of the first embodiment. As shown in FIG. 1, the radiographic image processing apparatus 100 is connected to an image pickup apparatus 20 to perform image processing on a radiographic image (input image) supplied from the image pickup apparatus 20.

The image pickup apparatus 20 is arranged so as to face with a radiation source 10 with a material body placed between the image pickup apparatus 20 and the radiation source 10. The material body is a target of radiographic image pickup. The radiation source 10 emits the radiation such as an X-ray. The image pickup apparatus 20 outputs an image which is generated as a result of logarithmic transform on a taken image. When the logarithmic transform is not performed, the radiographic image processing apparatus 100 according to the first embodiment performs multiplication and division processes instead of addition and subtraction processes.

The radiographic image processing apparatus 100 includes a radiographic image inputting unit 101, a moving and still object separating unit 110, a large and small object separating unit 120, object region detecting units 130a and 130b, a moving small object image generating unit 140, an object region processing unit 150, and a synthesizing unit 160.

The radiographic image inputting unit 101 receives the radiographic image output from the image pickup apparatus 20 as an input and supplies the received radiographic image (input image) to the moving and still object separating unit 110 and the large and small object separating unit 120.

The moving and still object separating unit 110 separates the moving object which is a moving material body from the still object which is a still material body in the input image. The moving and still object separating unit 110 includes a still object image generating unit 111, a frame memory 112, and a moving object image generating unit 113.

The still object image generating unit 111 compares a pixel value of a still object image and a pixel value of the input image of a current frame to compute the still object in the current frame. Here, the still object image is an image including only the still object of a previous frame stored in the frame memory 112.

Specifically, the still object image generating unit 111 computes difference between the pixel value of the still object image stored in the frame memory 112 and the pixel value of the input image, and the still object image generating unit 111 compares the computed value with a predetermined threshold to determine which of the pixel value of the input image, the original pixel value stored in the frame memory 112, and a weighted average value of the pixel value of the input image and the original pixel value is to be used as the pixel value of the still object image newly stored in the frame memory 112.

The still object image computed by the still object image generating unit 111 is temporarily stored in the frame memory 112, and used as the image to be supplied as an input to the still object image generating unit 111 in performing the process to another frame later. Therefore, the image supplied to the still object image generating unit 111 from the frame memory 112 is a result of previous operation in the still object image generating unit 111.

The frame memory 112 is a storing unit that stores the still object image computed by the still object image generating unit 111.

The moving object image generating unit 113 subtracts a pixel value of a coordinate in the still object image that is supplied from the still object image generating unit 111, from a pixel value of a corresponding coordinate of the input image for each coordinate of the input image, to set the resulting value as the pixel value of the coordinate. Thus, an image including only the moving object other than the still object can be output. Hereinafter, the image including only the moving object is referred to as moving object image.

The large and small object separating unit 120 separates the large object which is larger than the object having the predetermined size from the small object which is an object other than the large object in the input image. The large and small object separating unit 120 includes a large object computing unit 121 and a small object image generating unit 122.

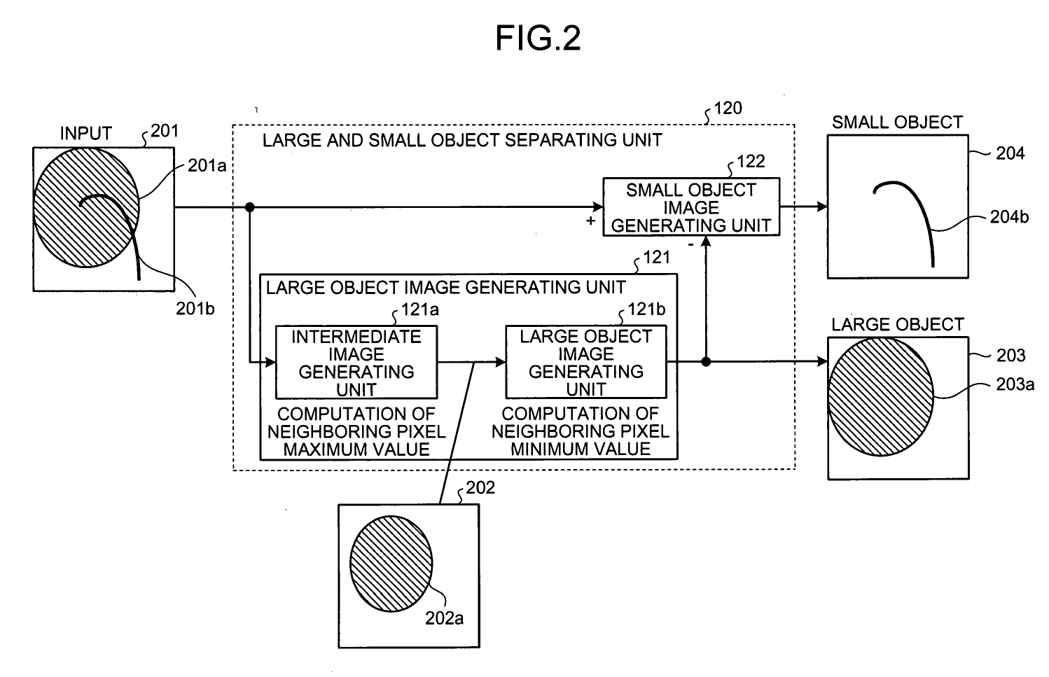

FIG. 2 is a block diagram showing a detailed configuration of the large and small object separating unit 120. As shown in FIG. 2, the large object computing unit 121 includes an intermediate image generating unit 121a and a large object image generating unit 121b.

The intermediate image generating unit 121a computes a maximum pixel value of pixels around a pixel in the input image, for pixels of respective coordinates in the input image, to set the maximum pixel value as the pixel value of the pertinent coordinate in an intermediate image which is supplied as an output. The intermediate image computed by the intermediate image generating unit 121a is supplied to the large object image generating unit 121b.

In the case of the radiographic image, the pixel value in the region where the object exists is smaller than the pixel values in the neighboring region where the object does not exist. Hence, when the maximum pixel value among the pixels existing within a predetermined range for each pixel is set as the pixel value of the pertinent pixel, an edge portion of the object is removed (cut). Hereinafter, the object whose edge is cut is referred to as shrunken object.

The neighboring pixels existing within the predetermined range for a certain pixel shall mean a set of pixels existing within a predetermined constant distance R1 from the certain pixel. In this case, the shrunken object in which the edge portion of the object is cut by the distance R1 through the process in the intermediate image generating unit 121a is output.

Therefore, in the object whose both edge portions are included in the predetermined range, e.g., in the object which is smaller than the distance R1, the whole region of the object is cut, and the object does not remain in the intermediate image output by the intermediate image generating unit 121a.

Contrary to the intermediate image generating unit 121a, with respect to the pixel of each coordinate on the input image, the large object image generating unit 121b computes the minimum pixel value of the neighboring pixels existing within the predetermined range for the pixel to set the minimum pixel value as the pixel value of the corresponding coordinate in an output image. The object in the input image of the large object image generating unit 121b is enlarged toward the surroundings through this process at the edge portion.

In the large object image generating unit 121b, the neighboring pixels existing within the predetermined range for a certain pixel shall mean a set of pixels existing within a predetermined constant distance R2 from the certain pixel.

When the distance R1 and the distance R2 are equal to each other, and commonly represented as R, the object edge is cut by distance R by the intermediate image generating unit 121a, and the object edge is expanded by the distance R by the large object image generating unit 121b. Therefore, in the object which is larger than the distance R, namely, in the object whose both edge portions are not included in the predetermined range, a shape of the object is not changed by the process in the large object computing unit 121.

The object which is smaller than the distance R1, i.e., the object whose both edge portions are included in the predetermined range is eliminated through the process in the intermediate image generating unit 121a, and the object is not expanded in the large object image generating unit 121b. Accordingly, the object which is smaller than the distance R1 is eliminated through the process in the large object computing unit 121.

Thus, the object which is smaller than the distance R1 is eliminated in the large object computing unit 121, and the image in which only the large object remains is output. It is not always necessary that the distance R1 and the distance R2 are equal to each other. However, an artifact that the edge of the large object is computed in the small object image generating unit 122 can be minimized by equalizing the distance R1 and the distance R2.

Since the image in which only the large object is extracted from the input image is output through the process in the large object image generating unit 121b, hereinafter the output image of the large object image generating unit 121b is referred to as large object image.

The small object image generating unit 122 subtracts the pixel value of the large object image from the pixel value of the input image. Therefore, the output image of the small object image generating unit 122 becomes an image in which influence of the large object is removed from the input image, namely, an image including only the small object (hereinafter referred to as small object image).

For example, in the case of the material body having a small projection, when the both edge portions of the projection are included in the predetermined range, the whole region of the projection are cut, and the shrunken object in which the edge portion of the material body is cut is output. The material body in which the projection is cut through the process in the large object image generating unit 121b is output as the large object. The projection is computed as the small object through the process in the small object image generating unit 122. Thus, in the present embodiment, irrespective of integrity of the actual material body, the material body is separately processed in each unit based on an object to be output from each unit.

An example of the image to be processed by the large and small object separating unit 120 will be described below with reference to FIG. 2. When the large and small object separating unit 120 receives an input image 201 as shown in FIG. 2 as an input, the intermediate image generating unit 121a processes the input image 201 so that the edge of a large object 201a in the input image 201 is cut, and outputs an intermediate image 202 including a large object 202a. The intermediate image 202 does not include a small object 201b which is present in the input image 201.

Then, the large object image generating unit 121b processes the intermediate image 202 so as to enlarge the large object 202a at the edge portion, and output a large object image 203 including a large object 203a. Then, the small object image generating unit 122 subtracts the large object image 203 from the input image 201 and outputs a small object image 204 including only a small object 204b.

In the above example, the distances R1 and R2 referred to in the intermediate image generating unit 121a and the large object image generating unit 121b respectively are set at the predetermined fixed values. The distances R1 and R2, however, may arbitrarily be specified from the outside.

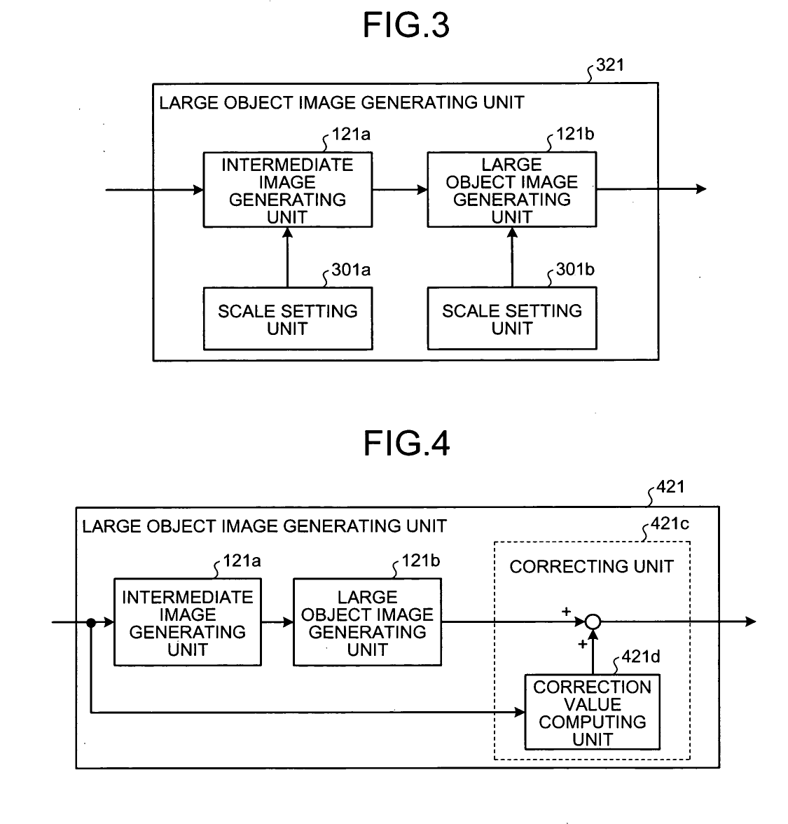

FIG. 3 is a block diagram showing a configuration of a large object computing unit 321, which is an alternative example of the large object computing unit 121, having the above described configuration. As shown in FIG. 3, scale setting units 301a and 301b are provided for the intermediate image generating unit 121a and the large object image generating unit 121b respectively, so that the distances R1 and R2 can be arbitrarily specified by a user or an external computing unit (not shown).

Still alternatively, the large object computing unit 121 may perform image correction. FIG. 4 is a block diagram showing a configuration of such an alternative large object computing unit 421.

The large object computing unit 421 computes the maximum value and the minimum value of the neighboring pixel value as described above. When the image input to the large object computing unit 421 is the image including many noises, the pixel value of the intermediate image output from the large object computing unit 421 may be shifted from the value indicating a shadow of the target large object.

When the noises included in the image supplied to the large object computing unit 421 is too large so as to generate a substantial error in the intermediate image output from the large object computing unit 421, a correcting unit 421c can be provided in the large object computing unit 421 as shown in FIG. 4.

The correcting unit 421c includes a correction value computing unit 421d. The correction value computing unit 421d computes a correction value according to a relation which is previously computed with respect to the error between the pixel value of the image input to the large object computing unit 421 and the pixel value obtained by the computations of the maximum value and the minimum value.

The correction value computing unit 421d computes the correction value using a lookup table in which parameters used in the correction value computation for each pixel value of the input image are stored, e.g., a lookup table in which a correlation between the pixel value of the input image and the correction value is stored. The correction value computing unit 421d may be configured by a function computing unit which computes the correction value for the pixel value of the input image. A linear operation which is a simple combination of the multiplication and the addition expressed, for example, by an equation of F(x)=Ax+B (where x: pixel value of input image, F(x): correction value, A and B: constant) can also be used in the computation of the function computing unit.

The object region detecting units 130a and 130b detect the region where the object exists from the input image. In the first embodiment, the moving object image output from the moving object image generating unit 113 is input to the object region detecting unit 130a, and the object region detecting unit 130a detects and outputs the region where the moving object exists. The small object image output from the small object image generating unit 122 is input to the object region detecting unit 130b, and the object region detecting unit 130b detects and outputs the region where the small object exists.

Specifically, the object region detecting units 130a and 130b compare the pixel value of each coordinate with a predetermined threshold. When the pixel value is smaller than the threshold, a mask image in which the pixel value is “true” is output. When the pixel value is equal to or larger than the threshold, the mask image in which the pixel value is “false” is output. Hereinafter the mask image output corresponding to the moving object image is referred to as moving object mask, and the mask image output corresponding to the small object image is referred to as small object mask.

The object region detecting unit 130a differs from the object region detecting unit 130b in the input image and the predetermined threshold, while the object region detecting unit 130a is similar to the object region detecting unit 130b in contents of the process. For the threshold, the proper value is set according to the input image, i.e., depending on whether the input image is the moving object image or the small object image.

Generally the process in the object region detecting units 130a and 130b is called region detection or binarization. The region detection process in the object region detecting units 130a and 130b can be performed with the use of any generally-employed region detection process such as the region detection process described in Til Aach, Andre Kaup and Rudolf Mester, “Statistical model-based change detection in moving video,” Signal Processing 31(2): 165-180, 1993, or any generally-employed binarization process.

In the object region detecting units 130a and 130b, a noise reduction process may be performed to the input image as a pre-process of the region detection process. Any method generally used such as a MEDIAN filter, a Gaussian filter, and SUSAN Structure Preserving Noise Reduction (S. M. Smith and J. M. Brady, “SUSAN—a new approach to low level image processing,” International Journal of Computer Vision, 23(1), pp. 45-78, May 1997) can be applied to the noise reduction process.

For each coordinate, the moving small object image generating unit 140 computes a logical multiplication of the pixel value of the moving object mask output from the object region detecting unit 130a and the pixel value of the small object mask output from the object region detecting unit 130b. Then, the moving small object image generating unit 140 outputs a moving small object mask in which the logical multiplication value is set as the pixel value of the coordinate. The moving small object mask shall mean the mask image of the region including the moving small object.

The moving object mask indicates the region where the object in motion exists in the input image, and the small object mask indicates the region where the small object exists in the input image. Accordingly, the region which is indicated by the moving small object mask computed by the logical multiplication of the moving object mask and the small object mask indicates the region where the small object in motion exists in the input image, i.e., the region that includes the shadow of the guide wire, a catheter, or the like.

The small object image output from the small object image generating unit 122 and the moving small object mask output from the moving small object image generating unit 140 are input to the object region processing unit 150. The object region processing unit 150 performs the enhancement process to the pixel value of the small object image coordinate corresponding to the coordinate where the pixel value is “true” in the moving small object mask.

Specifically the object region processing unit 150 multiplies the pixel value of the small object image coordinate corresponding to the coordinate where the pixel value is “true” in the moving small object mask and a predetermined enhancement gain e, and outputs the multiplied value as the pixel value of the coordinate.

The gain e may be constant or the gain e may be externally input via a gain input unit. The gain e is not always constant in one frame, and a sigmoid function in which the input value is the pixel value of the image input to the object region processing unit 150, other functions, or the output value of the lookup table may be set as the gain e.

The object region processing unit 150 may perform the noise reduction process to the image input to the object region processing unit 150 as the pre-process of such processes. Any method generally used such as the MEDIAN filter, the Gaussian filter, and the SUSAN Structure Preserving Noise Reduction can be applied to the noise reduction process.

The object region processing unit 150 may be configured to perform only the noise reduction process without performing the image enhancement process. Because the individual noise reduction process can be performed to the large object image and the small object image even in such the configuration, the visibility improving process suitable to each region can be performed.

The synthesizing unit 160 outputs the image in which the pixel value of the image output from the object region processing unit 150 and the pixel value of the large object image output from the large object computing unit 121 are added in each coordinate. Thus, the synthesizing unit 160 separates the large object and the small object from each other, and outputs the image in which the visibility improving process such as the noise reduction process and the image enhancement process is performed to each of the large object and the small object.

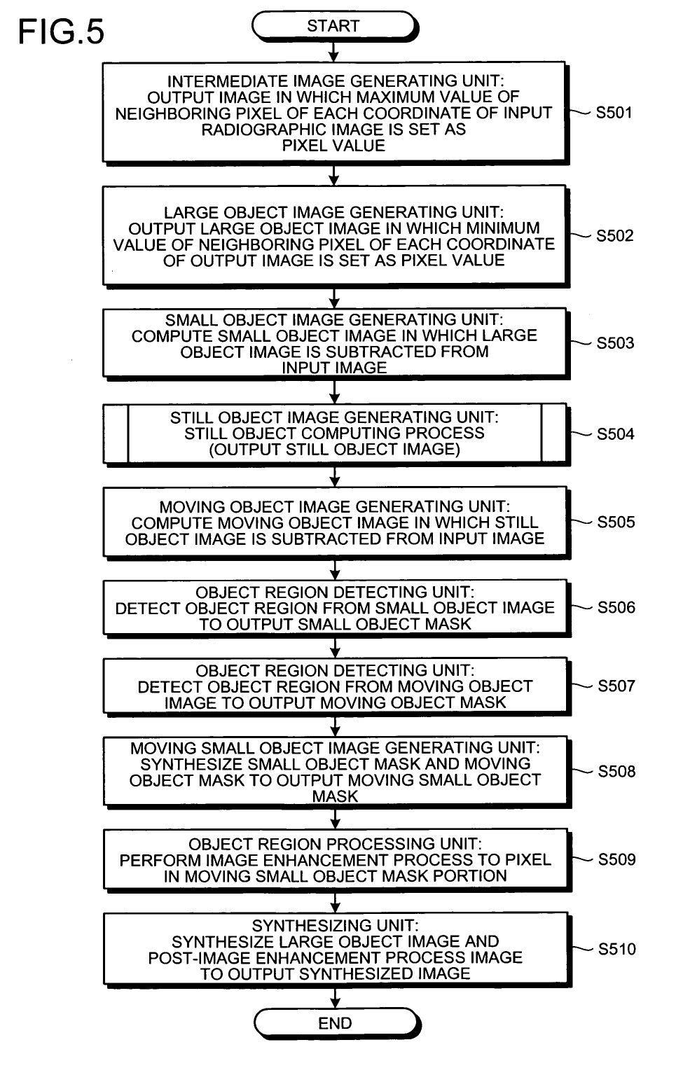

Then, the radiographic image processing performed by the radiographic image processing apparatus 100 of the first embodiment having the above configuration will be described. FIG. 5 is a flowchart showing an entire flow of the radiographic image processing in the first embodiment.

First, the process of separating the large object from the small object in the input radiographic image (input image) is performed by the intermediate image generating unit 121a, the large object image generating unit 121b, and the small object image generating unit 122 (Step S501 to Step S503). The intermediate image generating unit 121a, the large object image generating unit 121b, and the small object image generating unit 122 constitute the large and small object separating unit 120.

The intermediate image generating unit 121a outputs the image in which the maximum pixel value in the pixels existing within the predetermined range around each coordinate of the input image is set as the pixel value (Step S501). Thus, the intermediate image generating unit 121a outputs the shrunken object in which the edge of the large object whose both edge portions are not included in the predetermined range is cut. In the process of Step S501, the small object whose both edge portions are included in the predetermined range is eliminated.

The large object image generating unit 121b outputs the large object image in which the minimum pixel value in the pixels existing within the predetermined range around each coordinate of the image output from the intermediate image generating unit 121a is set as the pixel value (Step S502). Thus, the large object image generating unit 121b outputs the large object in which the shrunken object is enlarged at the edge portion. Since the small object is completely eliminated in Step S501, the small object is not enlarged in the process of Step S502.

The small object image generating unit 122 computes and outputs the small object image in which the large object image is subtracted from the input image (Step S503). Thus, the small object image generating unit 122 outputs the image including only the small object by removing the large object from the input image.

Then, the process of separating the still object and the moving object from the input image is performed by the still object image generating unit 111 and the moving object image generating unit 113 (Step S504 and Step S505). The still object image generating unit 111 and the moving object image generating unit 113 constitute the moving and still object separating unit 110. Because the process performed by the large and small object separating unit 120 and the process performed by the moving and still object separating unit 110 are independent of each other, the process performed by the moving and still object separating unit 110 may performed in advance, or the processes may be performed concurrently.

The still object image generating unit 111 performs a still object computing process (Step S504). In the still object computing process, the still object image generating unit 111 computes the still object image from the input image, and outputs the still object image which is the image including only the still object. The still object computing process will be described in detail later.

The moving object image generating unit 113 computes and outputs the moving object image in which the still object image is subtracted from the input image (Step S505).

Then, the object region detecting unit 130b detects the object region from the small object image output by the small object image generating unit 122, and outputs the small object mask (Step S506).

Similarly, the object region detecting unit 130a detects the object region from the moving object image output by the moving object image generating unit 113, and outputs the moving object mask (Step S507).

The moving small object image generating unit 140 synthesizes and outputs the moving small object mask from the small object mask and the moving object mask (Step S508).

The object region processing unit 150 performs the image enhancement process to the pixel in the moving small object mask portion (Step S509). Specifically, the small object image output from the small object image generating unit 122 and the moving small object mask output from the moving small object image generating unit 140 are input to the object region processing unit 150. For each coordinate of the small object image, when the pixel value of the moving small object mask is “true”, the pixel value of the coordinate is multiplied by the enhancement gain e.

The synthesizing unit 160 synthesizes the large object image output from the large object computing unit 121 and the post-image enhancement process image output from the object region processing unit 150, and outputs the synthesized image (Step S510). Then, the radiographic image processing is ended.

Thus, in the first embodiment, the large object and the small object are separated from each other in the input image, the still object and the moving object are separated from each other in the input image at the same time, and the moving small object is extracted from the small object and the moving object to perform the image enhancement process to the moving small object. Therefore, the visibility of the small material body in motion can be improved. The noise reduction process can also be performed to the large object separated and computed. Therefore, not only the visibility of the large object can be improved, but also accuracy of the small object computing process or the like which is performed on the assumption that the noise is reduced in the large object can be improved.

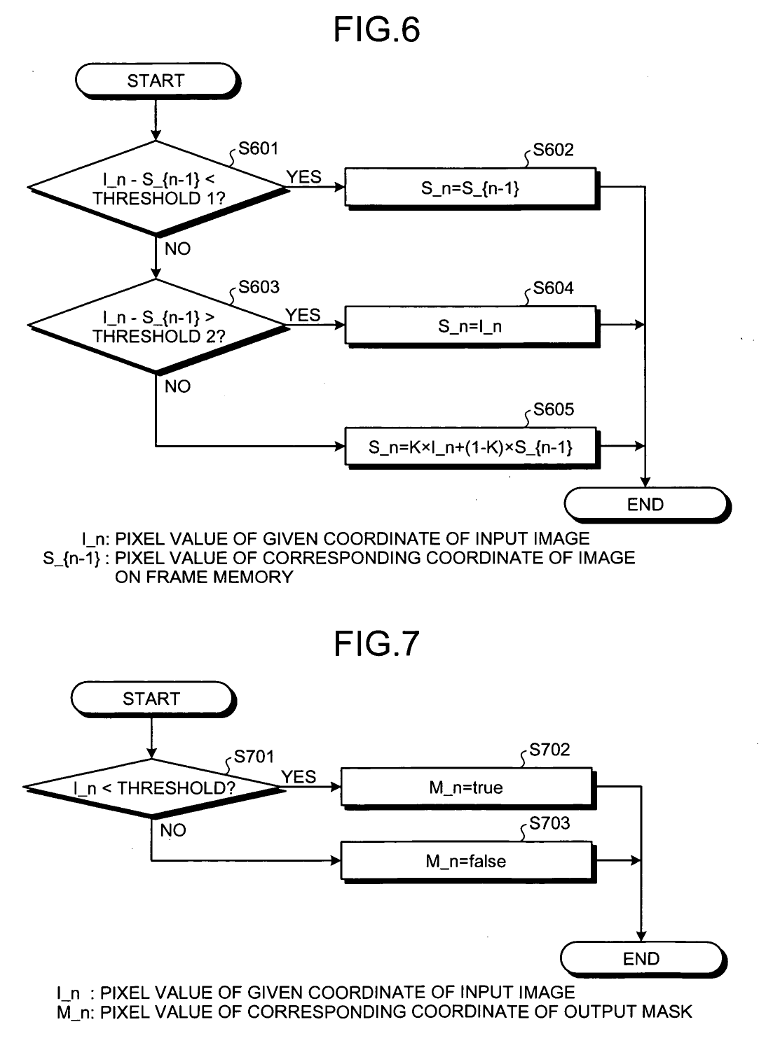

Then, the detailed still object computing process in Step S504 will be described. FIG. 6 is a flowchart showing an entire flow of the still object computing process.

In FIG. 6, the sign I_n denotes the pixel value of an arbitrary coordinate on the image input to the moving and still object separating unit 110, the sign S_{n−1} denotes the pixel value of the corresponding coordinate on the image input from the frame memory 112, and the sign S_{n} denotes the pixel value of the corresponding coordinate on the still object image output from the still object image generating unit 111. The operation shown in FIG. 6 is performed to all the pixels in the frame as the operation performed to one frame by the still object image generating unit 111.

The still object image generating unit 111 determines whether the value in which S_{n−1} is subtracted from I_n is smaller than a predetermined threshold 1 or not (Step S601). When the value in which S_{n−1} is subtracted from I_n is smaller than the threshold 1 (Yes in Step S601), S_{n−1} is set as the pixel value S_{n} of the still object image to be output (Step S602), and the process to the pixel is ended.

In the present embodiment, the negative value is set as the threshold 1. Accordingly, when the value in which S_{n−1} is subtracted from I_n is smaller than the predetermined threshold 1 which is the negative value, the value of I_n is smaller than the value of S_{n−1}. On the other hand, in the case of the radiographic image, as described above, the pixel value of the region where the object exists is smaller than the pixel value of the region where the object does not exist. Accordingly, when the value of I_n is small, the value of I_n can be regarded as the pixel value on the object.

When the value of I_n is smaller than the pixel value S_{n−1} of the still object image of the previous frame, the object in which I_n exists can be regarded as the moving object. In other words, I_n can be regarded as the pixel value on the moving object.

Accordingly, in Step S602, I_n is not set as the pixel value of the still object image to be output, but S_{n−1} which is the same value as the previous frame is set.

In Step S601, when the value in which S_{n−1} is subtracted from I_n is equal to or larger than the threshold 1 (No in Step S601), the still object image generating unit 111 determines whether the value in which S_{n−1} is subtracted from I_n is larger than a predetermined threshold 2 or not (Step S603).

When the value in which S_{n−1} is subtracted from I_n is larger than the predetermined threshold 2 (Yes in Step S603), I_n is set as the pixel value S_{n} of the still object image to be output (Step S604), and the process to the pixel is ended.

In the present embodiment, the positive value is set as the threshold 2. Accordingly, when the value in which S_{n−1} is subtracted from I_n is larger than the predetermined threshold 2 which is the positive value, S_{n−1} is the pixel value on the moving object in the previous frame, and it can be regarded that the moving object has been moved and does not exist in the current frame.

Accordingly, in Step S604, I_n which is the pixel value of the input image of the current frame is set as the pixel value of the still object image to be output.

In Step S603, the value in which S_{n−1} is subtracted from I_n is equal to or smaller than the threshold 2 (No in Step S603), the still object image generating unit 111 sets the value which is the weighted average value of I_n and S_{n−1} with a weighting coefficient K as the pixel value S_n of the still object image (Step S605), and the process to the pixel is ended.

This is because it can be regarded that both I_n and S_{n−1} are not the pixel value on the moving object. The value K used in computing the weighted average of I_n and S_{n−1} is a weight to the current value.

Thus, in the moving and still object separating unit 110, the still object image generating unit 111 compares the still object image, which is the result of previous computation, and the current input image. Therefore, the image of the still object in the input image to the moving and still object separating unit 110 can be computed in a recursive manner.

The detailed object region detection process in Step S506 and Step S507 will be described. FIG. 7 is a flowchart showing an entire flow of the object region detection process.

In FIG. 7, the sign I_n denotes the pixel value of an arbitrary coordinate on the input image to the object region detecting unit 130a or 130b, and the sign M_n denotes the pixel value of the corresponding coordinate on the output mask image output from the object region detecting unit 130a or 130b. It is assumed that the output mask has the “true” or “false” pixel value in each coordinate. The operation shown in FIG. 7 is performed to all the pixels in the frame as the operation performed to one frame by the object region detecting unit 130a or 130b.

The object region detecting unit 130a or 130b determines whether I_n is smaller than a predetermined threshold or not (Step S701). When I_n is smaller than the threshold (Yes in Step S701), since I_n can be regarded to exist in the object region, “true” is set as the pixel value M_n of the output mask image (Step S702), and the process to the pixel is ended.

When I_n is equal to or larger than the threshold (No in Step S701), since I_n can be regarded as the pixel value outside the object region, “false” is set as the pixel value M_n of the output mask image (Step S703), and the process to the pixel is ended.

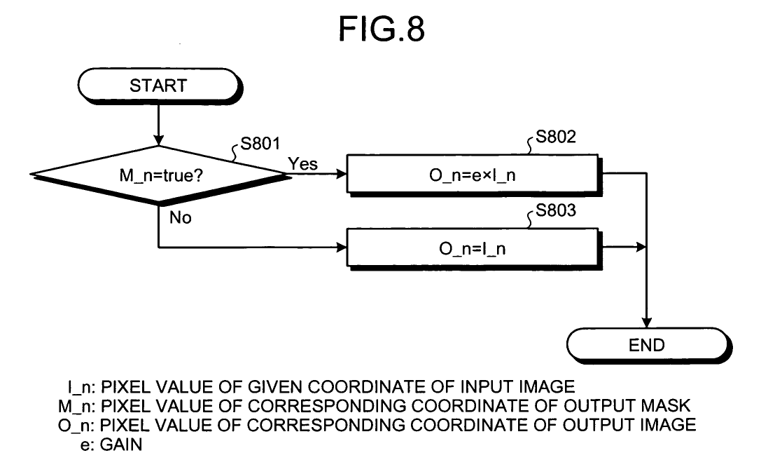

Then, the detailed image enhancement process in Step S509 will be described. FIG. 8 is a flowchart showing an entire flow of the image enhancement process.

In FIG. 8, the sign I_n denotes the pixel value of an arbitrary coordinate on the input image to the object region processing unit 150, the sign M_n denotes the mask value of the corresponding coordinate on the input mask, and the sign O_n denotes the pixel value of the corresponding coordinate of the image output from the object region processing unit 150. The operation shown in FIG. 8 is performed to all the pixels in the frame as the operation performed to one frame by the object region processing unit 150.

The object region processing unit 150 determines whether M_n is “true” or not (Step S801). When M_n is “true” (Yes in Step S801), the value in which I_n is multiplied by the enhancement gain e is set as O_n (Step S802), and the process to the pixel is ended. When M_n is “false” (No in Step S801), I_n is set as O_n (Step S803), and the process to the pixel is ended.

The image enhancement can be performed only to the region where the moving small object exists by the above process of the object region processing unit 150.

Thus, in the radiographic image processing apparatus 100 of the first embodiment, since the region where the large material body exists and the region where the small material body exists can be separated from the radiographic image, the visibility improving process suitable to the individual region can be performed. Particularly, since the small material body in motion can be separated to perform the visibility improving process, the small material body in motion such as the small medical tool can be clearly confirmed in the radiographic image displayed in the radiation diagnosis apparatus.

In the first embodiment, the moving object and still object separation process and the large object and small object separation process are concurrently performed, and the visibility improving process is performed to the moving small object computed by synthesizing the moving object and the small object. However, in the method described in the first embodiment, when the large object in motion and the still small object overlap in one region, such region may be erroneously extracted as a region of the moving small object. This is because the moving small object is computed by simple synthesis of the moving object and the small object.

Therefore, in a radiographic image processing apparatus according to a second embodiment of the invention, the large object and the small object are first separated, and the moving object and still object separation process is performed to the separated small object. The visibility improving process is performed to the moving small object (moving object separated from small object) separated in the above manner.

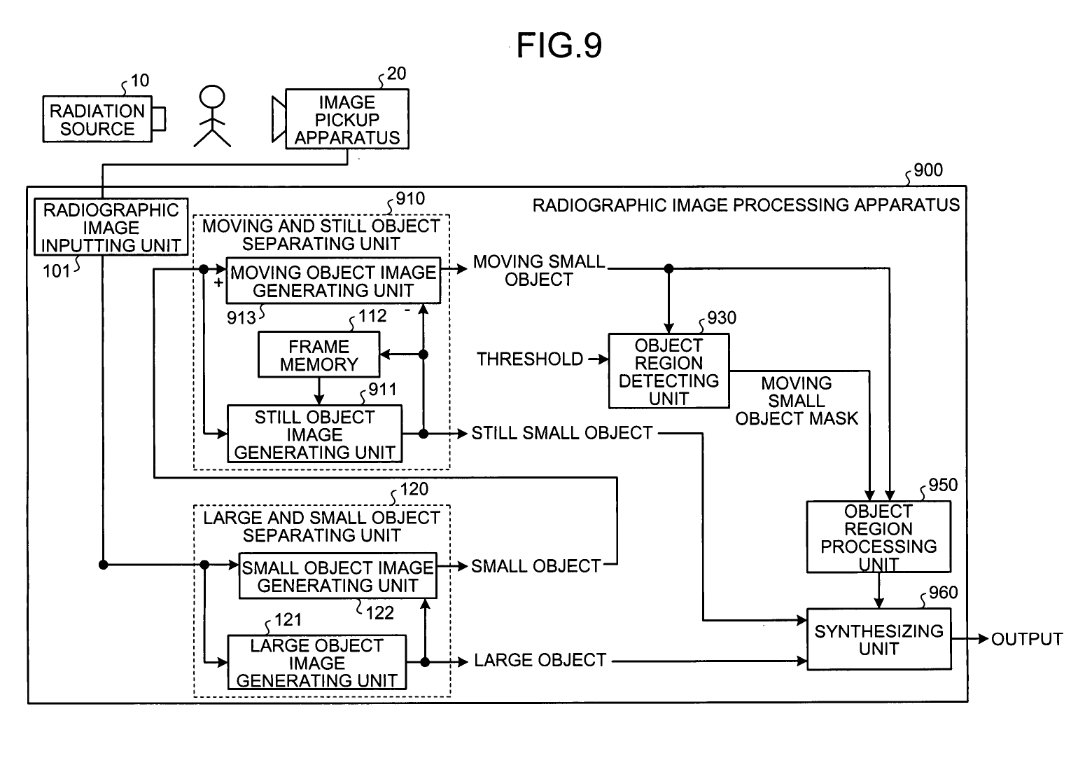

FIG. 9 is a block diagram showing a configuration of a radiographic image processing apparatus 900 of the second embodiment. As shown in FIG. 9, the radiographic image processing apparatus 900 includes a moving and still object separating unit 910, the large and small object separating unit 120, an object region detecting unit 930, an object region processing unit 950, and a synthesizing unit 960.

The second embodiment differs from the first embodiment in the images input to a still object image generating unit 911, a moving object image generating unit 913, the object region detecting unit 930, the object region processing unit 950, and the synthesizing unit 960. The second embodiment also differs from the first embodiment in that the moving small object image generating unit 140 is eliminated. Other components and functions are the same as those shown in FIG. 1 which is the block diagram showing the configuration of the radiographic image processing apparatus 100 of the first embodiment, and hence the components and functions are denoted by the same reference numerals and signs and the description is not repeated here.

In the first embodiment, the radiographic image input in the current frame is input to the still object image generating unit 111. On the contrary, in the second embodiment, the small object image output from the small object image generating unit 122 is input to the still object image generating unit 911. Otherwise the still object computing process is similar to that in the first embodiment.

Because the still object image generating unit 911 outputs the image including only the still object in the small object image, hereinafter the image output from the still object image generating unit 911 is referred to as still small object image.

Similarly to the still object image generating unit 911, the moving object image generating unit 913 differs from the moving object image generating unit 113 of the first embodiment in that the input image is the small object image output from the small object image generating unit 122. Otherwise the moving object computing process is similar to that in the first embodiment, and the description will not be repeated here.

In the second embodiment, the moving and still object separation process can be performed only to the small object, which is separated and output by the large and small object separating unit 120, by changing the image to be processed.

Because the moving object image generating unit 913 outputs the image including only the moving object in the small object image, hereinafter the image output from the moving object image generating unit 913 is referred to as moving small object image.

The object region detecting unit 930 differs from the object region detecting units 130a and 130b of the first embodiment in that the moving small object image output from the moving object image generating unit 913 is input to the object region detecting unit 930. Otherwise the object region detection process is similar to that of the first embodiment, and the description will not be repeated here.

The moving small object image output from the moving object image generating unit 913 and the moving small object mask output from the object region detecting unit 930 are input to the object region processing unit 950. The object region processing unit 950 performs the enhancement process to the pixel value of the moving small object image coordinate corresponding to the coordinate where the pixel value is “true” in the moving small object mask.

The synthesizing unit 960 adds the pixel values of the image output from the object region processing unit 950, the large object image output from the large object computing unit 121, and the still object image output from the still object image generating unit 911 in each coordinate, and outputs the resulting image.

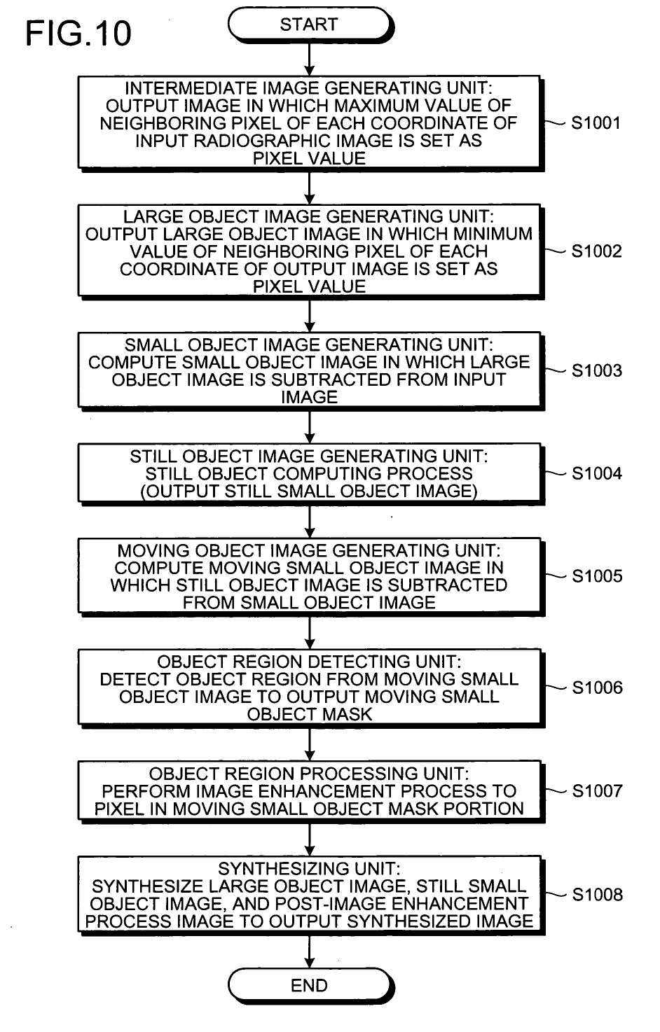

Then, the radiographic image processing performed by the radiographic image processing apparatus 900 of the second embodiment having the above configuration will be described. FIG. 10 is a flowchart showing an entire flow of the radiographic image processing in the second embodiment.

The large and small object separation process from Step S1001 to Step S1003 is similar to the process from Step S501 to Step S503 in the radiographic image processing apparatus 100 of the first embodiment, and the description will not be repeated here.

The still object computing process in Step S1004 differs from the still object computing process in Step S504 of the first embodiment in that, as described above, the input image is not the radiographic image input to the radiographic image processing apparatus but the small object image output from the small object image generating unit 122. Otherwise the process contents are similar to those in the first embodiment, and the description will not be repeated here.

After the still object computing process, the moving object image generating unit 913 computes and outputs the moving small object image in which the still object image is subtracted from the small object image (Step S1005).

Then, the object region detecting unit 930 detects the object region from the moving small object image output by the moving object image generating unit 913, and outputs the moving small object mask (Step S1006).

Then, the object region processing unit 950 performs the image enhancement process to the pixels in the moving small object mask portion (Step S1007).

Finally the synthesizing unit 960 synthesizes the large object image output from the large object computing unit 121, the still small object image output from the still object image generating unit 911, and the image to which the image enhancement process has been performed by the object region processing unit 950, and outputs the synthesized image (Step S1008), and the radiographic image processing is ended.

Thus, in the radiographic image processing apparatus 900 of the second embodiment, the large object and the small object are first separated, and the moving object can be separated from the separated small object. Therefore, the problem that the region where the moving large object and the still small object overlap each other is erroneously detected as the region where the moving small object exists can be avoided.

A radiographic image processing program executed in the radiographic image processing apparatus of the first embodiment or the second embodiment may be incorporated in ROM (Read Only Memory) or the like in advance and provided.

The radiographic image processing program executed in the radiographic image processing apparatus of the first embodiment or the second embodiment may be recorded in a computer-readable recording medium such as a Compact Disk Read Only Memory (CD-ROM), a flexible disk (FD), a Compact Disk Recordable (CD-R), and a Digital Versatile Disk (DVD) in the form of the installable file or in the form of the executable file and provided.

The radiographic image processing program executed in the radiographic image processing apparatus of the first embodiment or the second embodiment may be stored in a computer connected to a network such as the Internet and provided by performing download through the network. The radiographic image processing program executed in the radiographic image processing apparatus of the first embodiment or the second embodiment may be provided or distributed through a network such as the Internet.

The radiographic image processing program executed in the radiographic image processing apparatus of the first embodiment or the second embodiment has a module structure including the above components (moving object image generating unit, still object image generating unit, large object computing unit, small object image generating unit, object region detecting unit, moving small object image generating unit, object region processing unit, and synthesizing unit). In actual hardware, Central Processing Unit (CPU) reads the radiographic image processing program from the ROM and executes the radiographic image processing program, which loads each component on the main storage device to generate each component on the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radiographic image processing apparatus comprising:
a radiographic image inputting unit configured to input a radiographic image being a frame of moving picture taken radiographically;
an intermediate image generating unit configured to generate an intermediate image by computing a maximum pixel value as a pixel value of each pixel of the intermediate image, the maximum pixel value being a maximum pixel value of pixels within each area of a first size in a radiographic image, the each area of the first size including a pixel corresponding to the each pixel of the intermediate image;
a large object image generating unit configured to generate a large object image by computing a minimum pixel value as a pixel value of each pixel of the large object image, the minimum pixel value being a minimum pixel value of pixels within each area of a second size in the intermediate image, the each area of the second size including a pixel corresponding to the each pixel of the large object image; and
a small object image generating unit configured to generate a small object image by computing difference as a pixel value of each pixel of the small object image, the difference being difference of pixel values between the each pixel of the radiographic image and the each pixel of the large object image corresponding to the each pixel of the radiographic image.

2. The radiographic image processing apparatus according to claim 1, further comprising:
an image storing unit configured to store a still object image of a previous frame which is immediately before a given frame included in the moving image;
a still object image generating unit configured to generate a still object image by extracting the still object from the radiographic image in the given frame using the radiographic image in the given frame and the still object image in the previous frame, to store the still object image in the given frame in the image storing unit;
a moving object image generating unit configured to generate a moving object image by computing difference between a pixel value of each coordinate in the radiographic image in the given frame and a pixel value of a corresponding coordinate in the still object image generated by the still object image generating unit, for each coordinate in the radiographic image in the given frame, the moving object image being an image including a moving object other than the still object;
a moving small object image generating unit configured to generate a moving small object image by synthesizing the small object image and the moving object image, the moving small object image being an image including a moving small object which is both the moving object and the small object; and
an object region processing unit configured to perform an image enhancement process to the moving small object included in the moving small object image generated by the moving small object image generating moving small object image generating unit.

3. The radiographic image processing apparatus according to claim 1, further comprising:
an image storing unit configured to store a still small object image, the still small object image being an image generated by extraction of a still small object, which is a still object among small objects, from the small object image generated by the small object image generating unit in a previous frame of a given frame included in the moving image;
a still object image generating unit configured to generate the still small object image in the given frame based on the small object image generated by the small object image generating unit in the previous frame and the still small object image stored in the image storing unit, to store the still small object image in the given frame in the image storing unit;
a moving object image generating unit configured to generate a moving small object by computing difference between a pixel value of a coordinate in the small object image generated by the small object image generating unit in the given frame and a pixel value of a corresponding coordinate in the still small object image generated by the still object image generating unit, for each coordinate in the small object image, the moving small object image being an image including a moving small object other than the still small object; and
an object region processing unit configured to perform an image enhancement process to the moving small object included in the moving small object image generated by the moving object image generating unit.

4. The radiographic image processing apparatus according to claim 1, further comprising
a scale setting unit configured to receive an input of a numerical value, and sets the received numerical value as at least one of the first size and the second size referred to by at least one of the intermediate image generating intermediate image generating unit and the large object image generating large object image generating unit.

5. The radiographic image processing apparatus according to claim 1, further comprising
a correcting unit configured to correct an error included in the large object image generated by the large object image generating large object image generating unit.

6. The radiographic image processing apparatus according to claim 5, wherein
the correcting unit refers to a lookup table, which stores a parameter to be used for computation of a correction value for each pixel value of an input image, and computes the correction value for each pixel value of the input image, to correct the error included in the large object image with the correction value.

7. The radiographic image processing apparatus according to claim 5, wherein the correcting unit computes the correction value for each of the pixel values of the input image based on a predetermined function, and corrects the error included in the large object image with the correction value.

8. A method of processing a radiographic image, the method comprising:
inputting a radiographic image being a frame of moving picture taken radiographically;
generating an intermediate image by computing a maximum pixel value as a pixel value of each pixel of the intermediate image, the maximum pixel value being a maximum pixel value of pixels within each area of a first size in a radiographic image, the each area of the first size including a pixel corresponding to the each pixel of the intermediate image;
generating a large object image by computing a minimum pixel value as a pixel value of each pixel of the large object image, the minimum pixel value being a minimum pixel value of pixels within each area of a second size in the intermediate image, the each area of the second size including a pixel corresponding to the each pixel of the large object image; and
generating a small object image by computing difference as a pixel value of each pixel of the small object image, the difference being difference of pixel values between the each pixel of the radiographic image and the each pixel of the large object image corresponding to the each pixel of the radiographic image.

9. The method of processing a radiographic image according to claim 8, further comprising:
generating a still object image by extracting a still object from the radiographic image in the given frame using the radiographic image in the given frame and the still object image in the previous frame, to store the still object image in the given frame in the image storing unit;
generating a moving object image by computing difference between a pixel value of each coordinate in the radiographic image in the given frame and a pixel value of a corresponding coordinate in the still object image generated, for each coordinate in the radiographic image in the given frame, the moving object image being an image including a moving object other than the still object;
generating a moving small object image by synthesizing the small object image and the moving object image, the moving small object image being an image including a moving small object which is both the moving object and the small object; and
performing an image enhancement process to the moving small object included in the moving small object image generated.

10. The method of processing a radiographic image according to claim 8, further comprising:
generating a still small object image in a given frame based on the small object image generated in the computing the small object image of a given frame included in the moving image and a still small object image generated by extraction of a still small object which is a still object among small object and stored in an image storing unit, to store the still small object image in the image storing unit;
generating a moving object by computing difference between a pixel value of each coordinate in the small object image generated in the computing the small object image for the given frame and a pixel value of a corresponding coordinate in the still small object image generated in the computing the still object, the moving small object image being an image including a moving small object, the moving small object being an object other than the still small object; and
performing an image enhancement process to the moving small object included in the moving small object image generated in the computing the moving object.

11. The radiographic image processing method according to claim 8, further comprising
receiving an input of a numerical value and setting the received numerical value as at least one of the first size and the second size referred to in at least one of the generating the intermediate image and the generating the large object image.

12. The method of processing a radiographic image according to claim 8, further comprising correcting an error included in the large object image generated in the computing the large object image.

13. The method of processing a radiographic image according to claim 12, wherein
the correcting includes
referring to a lookup table, which stores a parameter to be used for computation of a correction value for each pixel value of an input image, and computing the correction value for each pixel value of the input image, to correct an error included in the large object image with the correction value.

14. The method of processing a radiographic image according to claim 12, wherein
the correcting includes
computing the correction value for each of the pixel values of the input image based on a predetermined function, and correcting the error included in the large object image with the correction value.

15. A computer program product for radiographic image processing having a computer readable medium including programmed instructions, wherein the instructions, when executed by a computer, cause the computer to perform:
inputting a radiographic image being a frame of moving picture taken radiographically;
generating an intermediate image by computing a maximum pixel value as a pixel value of each pixel of the intermediate image, the maximum pixel value being a maximum pixel value of pixels within each area of a first size in a radiographic image, the each area of the first size including a pixel corresponding to the each pixel of the intermediate image;
generating a large object image by computing a minimum pixel value as a pixel value of each pixel of the large object image, the minimum pixel value being a minimum pixel value of pixels within each area of a second size in the intermediate image, the each area of the second size including a pixel corresponding to the each pixel of the large object image; and
generating a small object image by computing difference as a pixel value of each pixel of the small object image, the difference being difference of pixel values between the each pixel of the radiographic image and the each pixel of the large object image corresponding to the each pixel of the radiographic image.

16. The computer program product according to claim 15 having a computer readable medium including programmed instructions, wherein the instructions, when executed by a computer, further cause the computer to perform:
generating a still object image by extracting a still object from the radiographic image in the given frame using the radiographic image in the given frame and the still object image in the previous frame, to store the still object image in the given frame in the image storing unit;
generating a moving object image by computing difference between a pixel value of each coordinate in the radiographic image in the given frame and a pixel value of a corresponding coordinate in the still object image generated, for each coordinate in the radiographic image in the given frame, the moving object image being an image including a moving object other than the still object;
generating a moving small object image by synthesizing the small object image and the moving object image, the moving small object image being an image including a moving small object which is both the moving object and the small object; and
performing an image enhancement process to the moving small object included in the moving small object image generated.

17. The computer program product according to claim 15 having a computer readable medium including programmed instructions, wherein the instructions, when executed by a computer, further cause the computer to perform:
generating a still small object image in a given frame based on the small object image generated in the computing the small object image of a given frame included in the moving image and a still small object image generated by extraction of a still small object which is a still object among small object and stored in an image storing unit, to store the still small object image in the image storing unit;
generating a moving object by computing difference between a pixel value of each coordinate in the small object image generated in the computing the small object image for the given frame and a pixel value of a corresponding coordinate in the still small object image generated in the computing the still object, the moving small object image being an image including a moving small object, the moving small object being an object other than the still small object; and
performing an image enhancement process to the moving small object included in the moving small object image generated in the computing the moving object.

18. The computer program product according to claim 15 having a computer readable medium including programmed instructions, wherein the instructions, when executed by a computer, further cause the computer to perform:
receiving an input of a numerical value and setting the received numerical value as at least one of the first size and the second size referred to in at least one of the generating the intermediate image and the generating the large object image.

19. The computer program product according to claim 15 having a computer readable medium including programmed instructions, wherein the instructions, when executed by a computer, further cause the computer to perform:
correcting an error included in the large object image generated in the computing the large object image.
